(19) United States
(12) Patent Application Publication
(10) Pub. No.: US 2009/0206578 A1
(43) Pub. Date: Aug. 20, 2009

(54) Wheeled Walker

(76) Inventors: Nir Pizmony, Richmond (AU); Jon Seddon, Burwood (AU); Sean Moran, Burwood (AU)

Correspondence Address: The Halvorson Law Firm, Ste 130, 1757 E. Baseline Rd., Gilbert, AZ, 85233, US

(21) Appl. No.: 12/378,525

(22) Filed: Feb. 17, 2009

(30) Foreign Application Priority Data
Aug. 18, 2006 (AU) 2006904511
Aug. 20, 2007 (AU) PCT/AU2007/001191

(51) Int. Cl. A61H 3/04

(52) U.S. Cl. 280/648

(57) ABSTRACT

A wheeled walker having a pair of opposing front legs carrying front wheels on their lower ends, and a pair of opposing back legs carrying back wheels on their lower ends, a seat carried between opposing front legs and rear legs, and handles extending from an upper portion of the front or rear legs, the wheeled walker including a structure with the front and back legs offset and a first pivoting connection between the front or back legs and the seat and a second pivoting connection between the handles and the other of the front or back legs to allow collapse of the wheeled walker to a substantially planar storage form.

This application claims priority based upon PCT application PCT/AU2007/001191 filed on Aug. 20, 2007, which is a continuation of AU application 2006904511, filed on Aug. 18, 2006.

### FIELD OF THE INVENTION

This invention relates to a wheeled walker for assisting a user to walk along while being at least partially assisted by a supportable rolling article.

### BACKGROUND

A wheeled walker is also called a rollator. It can be considered in its fundamental form to combine a walking frame, the height of which is usually adjustable to accommodate different height users, and is fitted with wheels so that rather than lifting the walker to move, the user pushes it. Walkers are usually equipped with some mechanism for allowing the user to sit when desired such as in U.S. Pat. No. 1,448,783 issued in 1921. Other examples of early frames, which in function are still used in the modern wheeled walkers, are found in U.S. Pat. Nos. 4,211,309 and in 4,341,381. Further as shown in U.S. Pat. No. 5,865,065 there is often included hand brakes that can be operated to stop the wheeled walker momentarily or to lock the wheeled walker in place.

Due to this derivation of a walker from a walking frame a prime version of a walker such as sold under the trademark “Invacare Rollite” is virtually a walking frame having two inverted U shaped sides with cross member facing opposite each other and joined at a front by cross members connecting the two sides. At the bottom of the front legs are caster wheels while fixed direction rolling wheels are attached to the back legs. The structure forms the usual U shaped cavity within which the user can walk while using the top of the inverted U shaped sides as supporting ledges and directional handles.

The problems with such a structure is the lack of versatility of the article and particularly the space the walker takes as it is fundamentally stored and transported as is and therefore has no different transport volume to in use volume. Height adjustment is also only possible by telescoping the opposing legs and does not allow any variability of the position of the user relative to the walker. This can result in such a walker only providing support while the user is virtually within the U shaped cavity. It has limited ability to match the gait of the user.

A second version of walkers has two spaced handle structures fixedly attached and extending down to leaning upright linear legs extending to front distal ground-engaging fixed or caster wheels. Two backwardly extending rear linear legs extend at an angle from a middle portion of the front legs to respective back ground-engaging fixed wheels. This forms opposing side A frame supports with supporting cross members and the handles extending from the top of the A frames. Such walkers for example are sold under the trademarks Cosco Traveler and Lifecare Mobilator.

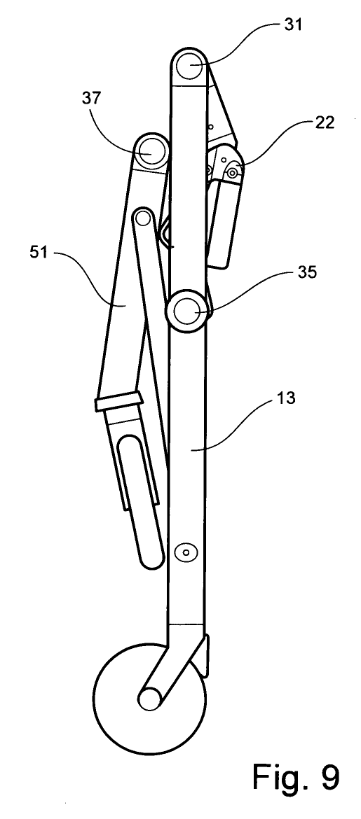

Improvements have been made over the years in the ability to fold a walker, either down its centre, as in U.S. Pat. No. 5,224,731 or in more modern versions by lifting the seat, and folding front to back as in U.S. Design Pat. No. 360,174, and in FIG. 9 of U.S. Pat. No. 5,865,065.

A deficiency of the modern walkers is the limitation in reducing size due to their limitation and stagnation of the fundamental design for decades. Also the height adjustment is always by telescoping elements, which therefore means the geometry of the walker, as a whole is not suitably adjusted to assist users of different heights or with different gaits.

### SUMMARY OF THE INVENTION

It is an object of the invention to provide a walker, which overcomes or at least ameliorates one or more problems of the prior art.

In particular it is an object of the invention to provide a walker, which is substantially more user friendly to a range of users both at time of purchase and in use.

In accordance with one aspect of the invention there is provided a wheeled walker having a pair of front legs carrying front wheels on their lower ends, a pair of back legs carrying back wheels on their lower ends, one or more cross members connecting the opposing front legs or rear legs, and a seat carried therebetween, the wheeled walker including at an upper end of the legs a pair of handles pivotably mounted, the handles further including a second pivot wherein the user can adjust the height of the handles while also adjusting the orientation.

Therefore it can be seen that the invention pivoting relationship between the handles and the main frame allow for at least 2 degrees of height adjustment of the handles where the handles are pivotable relative to the backrest and the backrest is pivotable relative to the main frame.

The invention also provides a novel configuration of a wheeled walker having a pair of forwardly extending back legs carrying back wheels on their lower ends and backwardly extending handles at their upper ends, a rear cross member connecting the rear legs, and a pair of front legs carrying front wheels on their lower ends connecting to a middle portion of the back legs, and an upper front cross member connecting the front legs, and a seat carried by at least one of the front and rear cross members.

Preferably the front and back legs are inwardly facing at such an angle relative to each other in an open in use position such that extrapolations of the front legs would substantially intersect at the top of the back legs.

The front legs and rear legs can be differently spaced and offset and the front legs pivotably mounted such that the front legs can fold and substantially coextend alongside the rear legs in a closed position.

The seat can extend between the front cross member and the rear cross member to space the front legs from the rear legs, the front legs being pivotably mounted to the seat and the seat being pivotably mounted to the rear legs whereby the seat and the front legs can fold and substantially coextend within the rear legs in a closed position.

Therefore it can be seen that unlike any previous walker the present walker includes foldability of the frame substantially flat by the configuration of the offset h-frame. Better and flatter folding capability results from the second set of hinged points and off-set frame/wheel geometry.

The invention also includes locking means at one or more of the pivot points at the extremities of the seat. The seat can include a central opening that allows a user to see their feet below the seat when in use. The seat can include in a perimetric located locking means in the seat and around the seat window that locks the one or more of the pivot points.

In a particularly preferred structure the seat includes four-point locking and the perimetric located locking means simultaneously locks and unlocks the four point locking at the pivot points at the spaced connections. The four point locking can be achieved by a centrally located arm extending around the seat window and engaging between opposing pairs of pivot locks to simultaneously lock or unlock the four point locking pivot points. The arms can engage cam means located in side cavities of the seat to provide the required engaging and disengaging action.

Therefore it can be seen that unlike any previous walker the present walker includes central control of 4 point collapsibility by opposing offset cam levers in seat structure and allows folding actuated by a single release mechanism that operates with a pull latch releasing a spring biased cam mechanism.

The invention also provides a wheeled walker having a pair of forwardly extending back legs carrying back wheels on their lower ends and backwardly extending handles at their upper ends, a rear cross member connecting the rear legs, and a pair of front legs carrying front wheels on their lower ends connecting to a middle portion of the back legs, and an upper front cross member connecting the front legs, and a seat carried by at least one of the front and rear cross members, the wheeled walker further including at an upper end of the back legs a pair of handles pivotably mounted, the handles further including a second pivot wherein the user can adjust the height of the handles while also adjusting the orientation.

Preferably the first and second pivots of the handles are spaced to allow the first pivot to provide a height difference of the handles relative to the top of the back legs and the second pivot to provide a difference in orientation of the handles due to difference in height to allow ready functional use of the handles.

Preferably the first and second pivots are separately lockable such that in the collapsing mode only the first pivot, providing the height adjustment, needs to pivot to locate the handles substantially alongside the back legs for compact transport. The second pivot will remain in separate locked position to prevent need for readjustment when handles are returned to correct position around first pivots when again in use.

Preferably the handles substantially overly the rear pivot connection of the seat to the back legs. This allows the user to walk between the lower parts of the back legs and receive suitable support from the walker.

Preferably a hooped support extends from the first pivot to form a backrest when the user is resting on the seat. The hooped support can pivot to substantially alongside the top of the back legs when in a compact transportable non-use position.

Preferably the front wheels are caster wheels to allow ready steering of the walker. The rear wheels can be fixed direction wheels. The respective attachment of the wheels to the lower ends of the front and rear legs is to allow alongside positioning in a compact transportable non-use position. This can be achieved when the front caster wheels are mounted centrally on the end of the front legs and the rear fixed wheels are mounted offset on the outer side of the back legs.

Preferably there are braking means activated by means attached to or adjacent the handles. The brake means can use wiring that can extend at least partially through or alongside the legs.

Due to the novel design and compact transportable non-use position the wheeled walker can be formed of chunky aerodynamically cross-section hollow tubular material to increase strength while maintaining ready usability.

### BRIEF DESCRIPTION OF THE INVENTION

In order that the invention is more readily understood an embodiment is disclosed with reference to the drawings wherein:

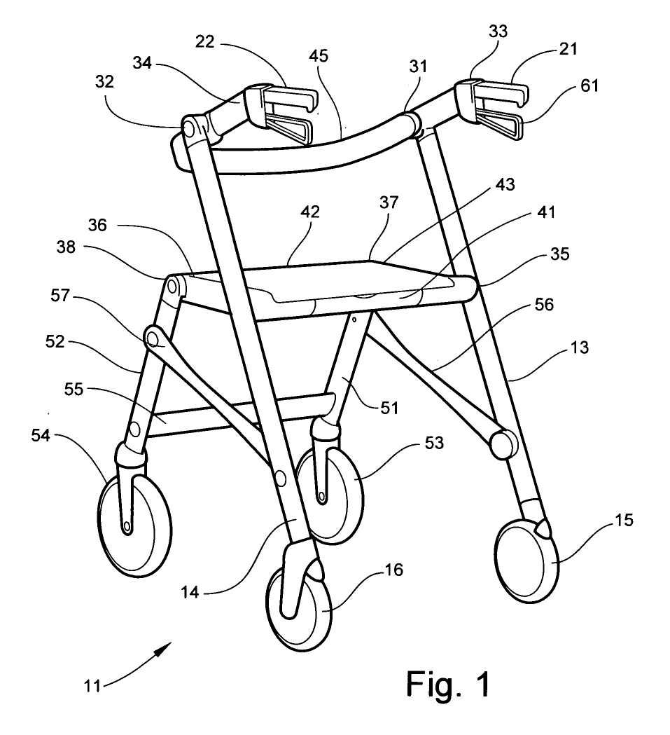

FIG. 1 is a perspective rear view of a walker in accordance with the invention;

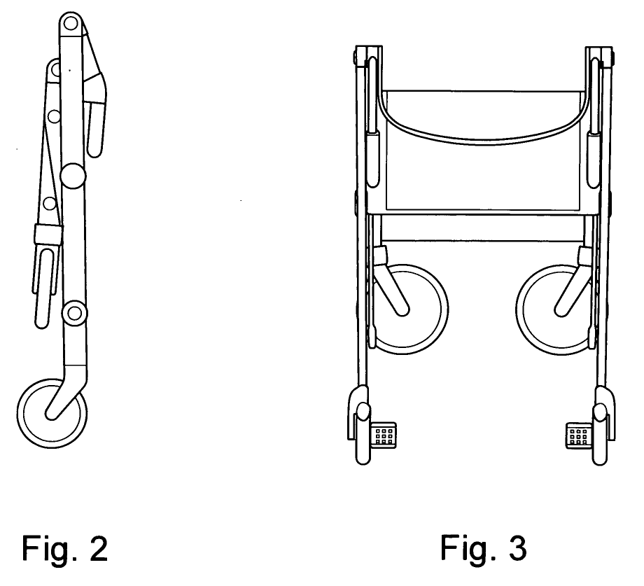

FIG. 2 is a side view of the walker of FIG. 1 in a closed position;

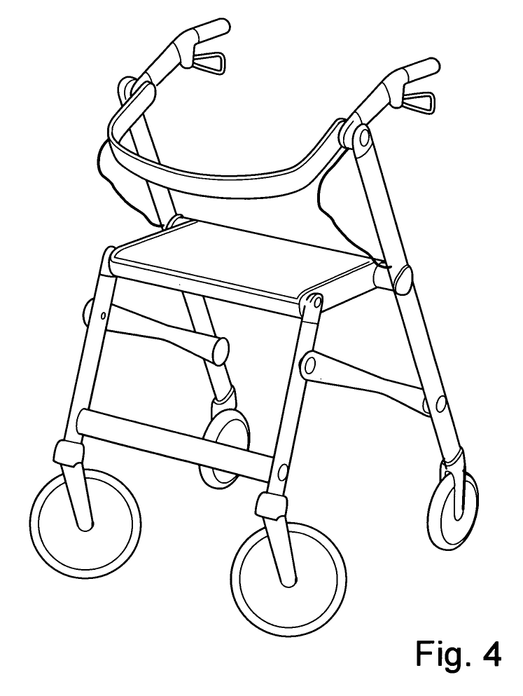

FIG. 3 is a rear view of the walker of FIG. 1 in a closed position;

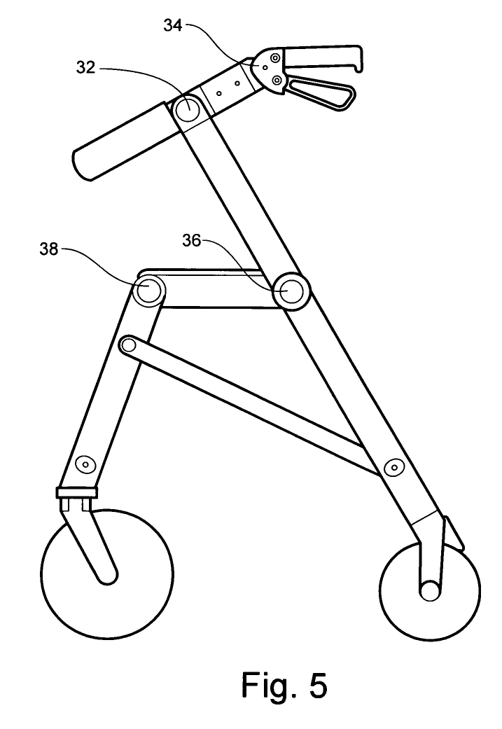

FIG. 4 is a perspective front view of the walker of FIG. 1 in an open position

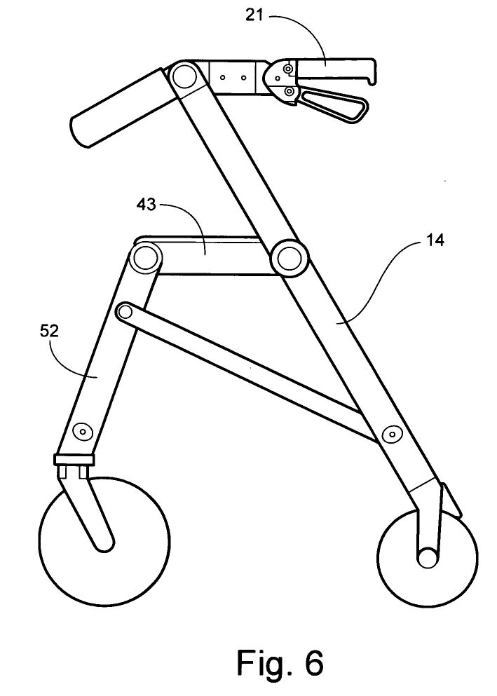

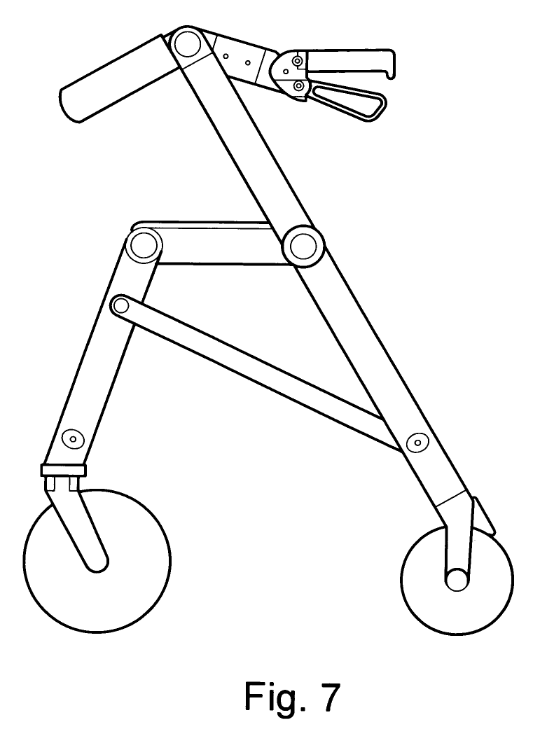

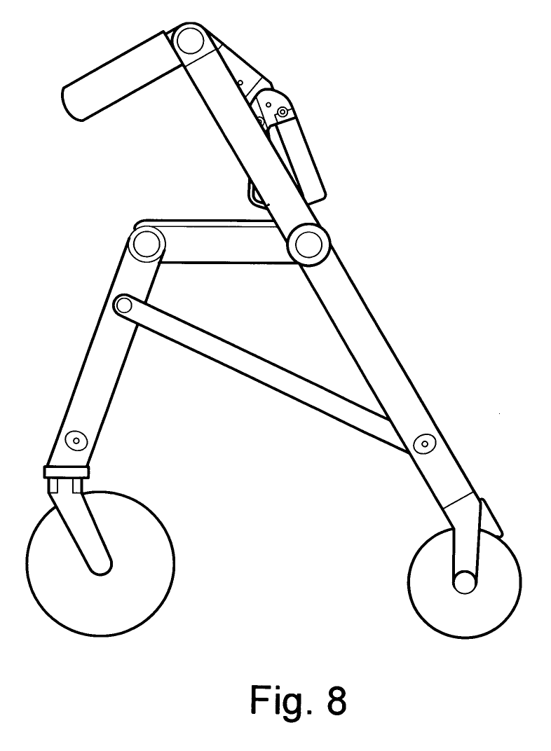

FIGS. 5, 6 and 7 are side diagrammatic views of the walker of FIG. 1 with the handle arrangement at high, medium and low heights;

FIG. 8 is a side diagrammatic view of the walker of FIG. 1 with the handle arrangement at particular orientation by second pivot but rotated around first pivot step in moving walker to a compact transportable non-use position;

FIG. 9 is a side diagrammatic view of the walker of FIG. 1 with the handle arrangement, front legs, seat and hooped back support at particular orientation in a compact transportable non-use position;

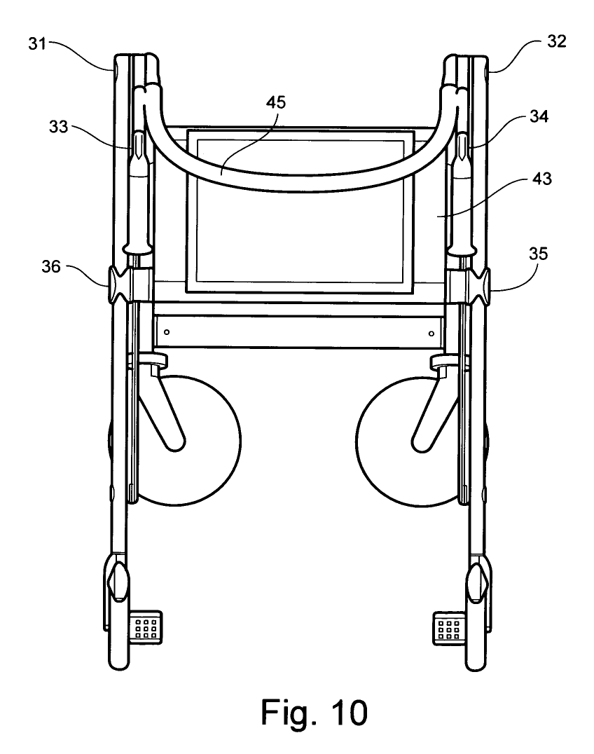

FIG. 10 is a front view of the walker of FIG. 9 in a compact transportable non-use position;

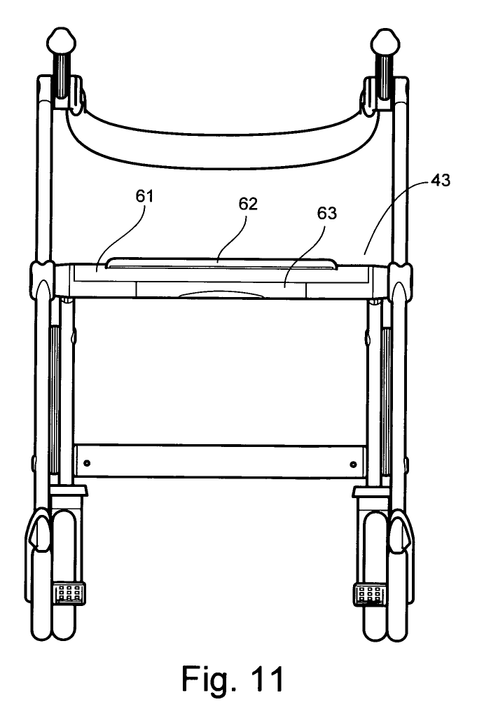

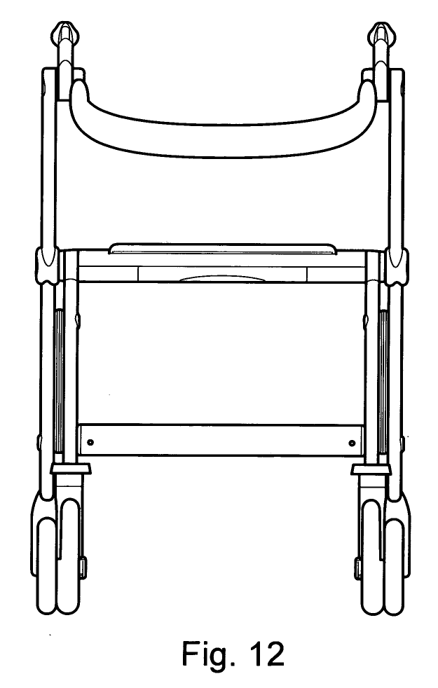

FIG. 11 is a rear view of the walker of FIG. 1 in an in use position;

FIG. 12 is a front view of the walker of FIG. 1 in an in use position;

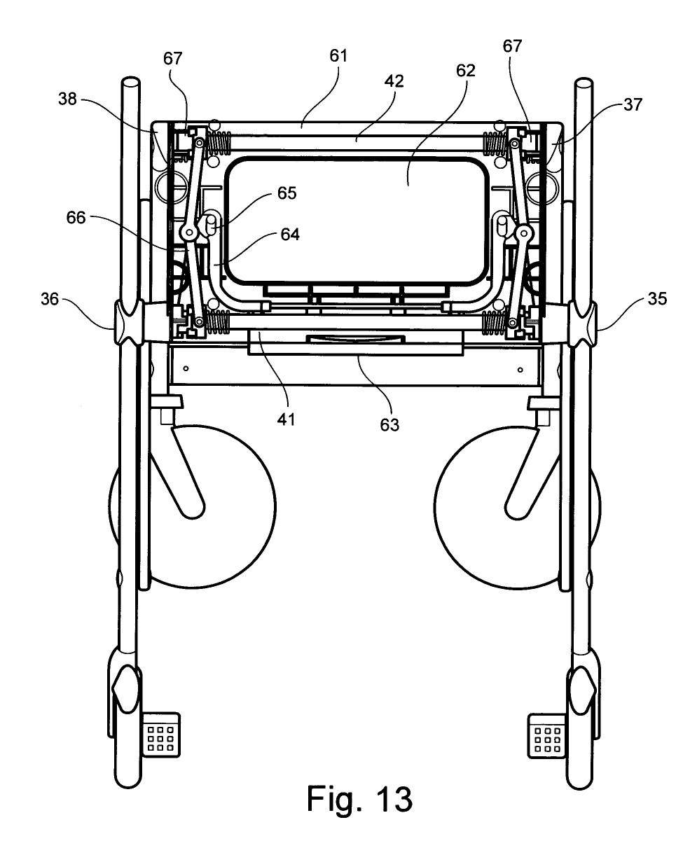

FIG. 13 is a functional rear exposed view of the working mechanism of the pivot locking system in an unlocked position and thereby the walker in a compact transportable non-use position;

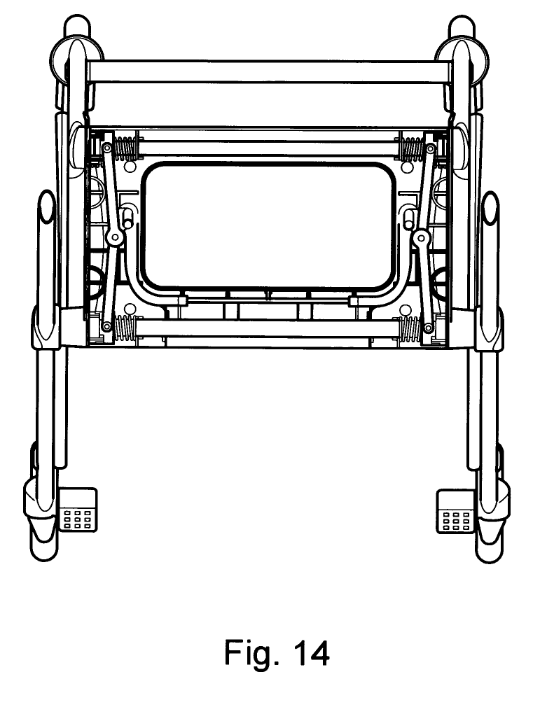

FIG. 14 is a functional overhead exposed view of the working mechanism of the pivot locking system in a locked position and thereby the walker in a in-use position;

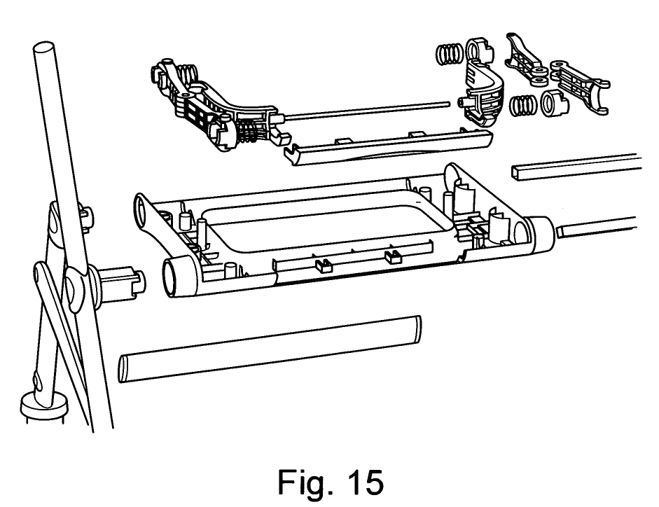

FIG. 15 is an exploded view of the working mechanism of the pivot locking system of FIGS. 13 and 14; and

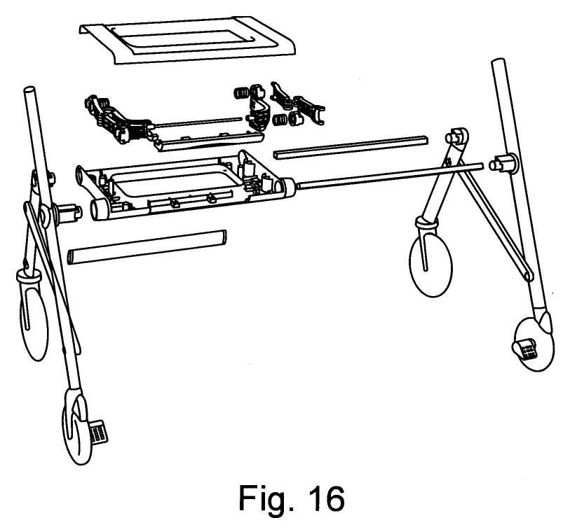

FIG. 16 is an exploded assembly view of the working mechanism of the pivot locking system of FIGS. 13 and 14 in the seat of the walker of FIG. 1.

### DESCRIPTION OF PREFERRED EMBODIMENT OF THE INVENTION

Referring to FIG. 1 of the drawings there is shown a wheeled walker 11 in an open in use position having a pair of forwardly leaning linear back legs 13, 14 carrying fixed direction back wheels 15, 16 on their lower ends. A rear cross member 41 connects the rear legs 13, 14.

There is also a pair of rearward leaning front legs 51, 52 carrying caster wheels 53, 54 on their lower ends. A front cross member 42 connects the tops of the front legs 51, 52 in a pivotable arrangement at pivot points 37, 38. A seat 43 extends between the rear cross member 41 and the front cross member 42.

In essence the structure thereby forms a “h” shape but with the back legs leaning forward in opposing direction to the rearward leaning front legs and the seat interspacing but connecting the front and rear legs at a mid section of the rear legs.

Further cross member 55 connecting between lower sections of respective front legs 51, 52 strengthen the front configuration. Pivotably mounted cross braces 56, 57 extending between upper portions of respective front legs and lower portions of respective back legs strengthen the torsional characteristics.

Referring to FIGS. 1 to 4 there is shown the in use foldability of the walker 11 around by use of the locking mechanism of the pivot points 35, 36, at the connection of the seat 43 to the rear legs 13, 14 and the pivot points 37, 38 at the connection of the seat 43 to the top of the front legs 51, 52. The operation of the locking mechanism will be further described later.

However it can be seen that due to the offset of the front legs to the back legs and the pivoting around the seat and the swivel of the front caster wheels the volume of the walker in an in use position of FIG. 1 is substantially reduces to the volume of the walker in a compact transportable non-use position. The novel construction and configuration provides a previously unattainable volume difference.

Rearward extending handles 21, 22 are pivotally connected at first pivots 31, 32 at the upper ends of the back legs 13, 14. The handles further include a second pivot 33, 34 wherein the user can adjust the height of the handles while also adjusting the orientation.

In particular referring to FIGS. 5 to 8 there is shown a high, medium and low height of the handles 21 by use of rotation around the first pivots 31, 32. However to allow the user to correctly and comfortably hold the handles there is suitable adjustment of the handles around second pivot 33, 34.

It can be seen that the first and second pivots of the handles are spaced to allow the first pivot to provide a height difference of the handles relative to the top of the back legs and the second pivot to provide a difference in orientation of the handles due to difference in height to allow ready functional use of the handles.

The first pivots 31, 32 and second pivots 33, 34 are separately lockable such that in the collapsing mode only the first pivot, providing the height adjustment, needs to pivot to locate the handles substantially alongside the back legs for compact transport. The second pivot will remain in separate locked position to prevent need for readjustment when handles are returned to correct position around first pivots when again in use.

A hooped support 45 extends from the first pivot to form a backrest when the user is resting on the seat 43. The hooped support 45 can pivot to substantially alongside the top of the back legs when in a compact transportable non-use position. Further since the handles can pivot around first pivot points 31, 32 as shown in FIG. 8 then unlike all current walkers, this wheeled walker suitably adjusts to be useable at a table or bench or the like.

The handles substantially overly the rear pivot connection of the seat to the back legs.

This allows the user to walk between the lower parts of the back legs and receive suitable support from the walker.

The front wheels 53, 54 are caster wheels to allow ready steering of the walker. The rear wheels can be fixed direction wheels. The respective attachment of the wheels to the lower ends of the front and rear legs is to allow alongside positioning in a compact transportable non-use position. This can be achieved when the front caster wheels are mounted centrally on the end of the front legs and due to their caster configuration can rotate in a closed position alongside the back legs as shown in FIG. 9.

There are braking means activated by means 61 attached adjacent the handles 21, 22. The brake means can use wiring that can extend at least partially through or alongside the legs.

Referring to FIGS. 9 to 12 the present walker includes foldability of the frame substantially flat by the configuration of the offset h-frame and the pivoting interconnection of the seat to the front and rear legs. Further the pivoting of the handles to the back legs results in a substantial side profile of the front and rear legs being longitudinally adjacent. In particular the first and second pivots 31, 32 and 33, 34 allow the handles to lie substantially contiguous with the rear legs 13, 14. Further due to the pivotal connection of the seat 43 by pivots 37, 38 to the top of the front legs 51, 52 and pivotal connection of the seat 43 by pivots 35, 36 to a middle portion of the rear legs 13, 14 the front legs 51, 52 lie substantially contiguous with the rear legs 13,14.

As shown in FIG. 11 the seat 43 includes a lid 62 closing a central opening in an annular seat structure 61 that allows a user to see their feet below the seat when in use. The seat includes in the perimetric or annular seat structure 61 a locking means around the seat window that locks the four pivot points 35, 36, 37, and 38 of the seat 43. The locking means of all the four pivot points is simultaneously operated by handle 63.

Referring to FIGS. 13 to 16 there is shown locking mechanism of the pivots 35, 36, 37, and 38 of the seat 43. At each pivot and at the lateral ends of the cross members 41, 42 at the front and back of the seat are located locking jams 67 that lock into the pivots to prevent pivotal movement of the seat 43 relative to the front and rear legs 51, 52, 13, 14. Therefore in the unlocked position with the locking jams 67 retracted inwards along the cross members 41, 42 as shown in FIG. 13, the seat 43 and legs do relatively move to a compact transportable non-use position. In the locked position with the locking jams 67 extended outwards along the cross members 41, 42 as shown in FIG. 14, the seat 43 and legs are restricted from relatively moving and so can lock the walker into an in-use position.

The mechanism that allows the four-point locking and the perimetric located locking means that simultaneously locks and unlocks the four point locking at the pivot points at the spaced connections is achieved by a centrally located arm 64 extending around the seat window 62 and having a cam 65 that engages centrally pivot arms 66 between opposing pairs of pivot locks to simultaneously lock or unlock the four point locking pivot points. The arms engage cam means located in side cavities of the seat and oppose springs on the cross members 41, 42 to provide the required engaging and disengaging action of the locking jams 67.

Therefore it can be seen that unlike any previous walker the present walker includes central control by a single handle 63. Simultaneous four point collapsibility is achieved by opposing offset cam levers in the seat structure and allows folding actuated by a single release mechanism that operates with the single handle 63 releasing a spring biased cam mechanism.

Due to the novel design and compact transportable non-use position the wheeled walker can be formed of chunky aerodynamically cross-section hollow tubular material to increase strength while maintaining ready useability.

Strong stable rigid durable construction with oval aluminium or steel frame. The structure has low bracing on front and rear legs. The lightweight aluminium construction is able to withstand up to 100 kilogram load. However a heavy-duty steel version could withstand over 100 kilograms. Lowered cost of manufacture and assembly with minimal welding and no tube bending.

The structure allows the walker to be packaged fully assembled and ready to use straight from the box. The compact folding design provides the smallest fold size of walkers in its class.

The design provides clean simple attractive and is user friendly with a generous seat width and depth and can be padded for extra comfort. Padded backrest self-locating on lower back for comfort. Backrest easily reversible for sitting at tables. Generous seat width and depth, padded for extra comfort and the width compares favourably while still minimising transport volume. Folds easily and safely but only possible when standing by use of pull handle and lift seat. Structure and construction allows getting around tight spaces easily.

There is easy and instant handle height adjustment without the need for tools or removable parts.

Range of seat heights available by providing different leg tube lengths. Flip up seat for shopping basket access or gait training (basket not shown) Ample space for shopping basket. Access from rear flap or under seat 200 mm diameter front castors for easy manoeuvrability and curb mounting. Front castors swivel off angled axis, reducing wobble for enhanced security Rear legs overcentre of axles. Enhances visual security of gait protection Curb jumping feature on both rear wheels Safety handbrakes with locking feature. Brake cables concealed in rear legs to avoid snagging on objects.

It should be understood that the above description is of a preferred embodiment and included as illustration only. It is not limiting of the invention. Clearly a person skilled in the art without any inventiveness would understand variations of the wheeled walker and such variations are included within the scope of this invention.

1. A wheeled walker having a pair of opposing front legs carrying front wheels on their lower ends, and a pair of opposing back legs carrying back wheels on their lower ends, a seat carried between opposing front legs and rear legs, and handles extending from an upper portion of the front or rear legs, the wheeled walker including a structure with the front and back legs offset and a first pivoting connection between the front or back legs and the seat and a second pivoting connection between the handles and the other of the front or back legs to allow collapse of the wheeled walker to a substantially planar storage form.

2. A wheeled walker according to claim 1 having at an upper end of the legs a pair of pivotably mounted handles having rearwardly protruding arms ending in hand grips with the handles further including a second pivot along the handles, wherein the user can adjust the height of the handles while also adjusting the orientation wherein the pivoting relationship between the handles and the main frame allow for at least 2 degrees of height adjustment of the handles.

3. A wheeled walker according to claim 1 with the back legs extending forwardly and with backwardly extending handles at their upper ends, a rear cross member connecting the back legs, and the front legs carrying connecting to a middle portion of the back legs, and an upper front cross member connecting the front legs, and the seat carried by at least one of the front and rear cross members.

4. A wheeled walker according to claim 3 wherein the front and back legs are inwardly facing relative to each other and at such an angle relative to each other that in an open in use position extrapolations of the front legs would substantially intersect at or near the top of the back legs.

5. A wheeled walker according to claim 4 wherein the front legs and rear legs are differently spaced and offset and the front legs pivotably mounted such that the front legs can fold and substantially coextend alongside an inner or outer surface of the rear legs in a closed position.

6. A wheeled walker according to claim 3 wherein the seat extends between the front cross member and the rear cross member to space the front legs from the rear legs, the front legs being pivotably mounted to the seat and the seat being pivotably mounted to the rear legs whereby the seat and the front legs can fold and substantially coextend within the rear legs in a closed position.

7. A wheeled walker according to claim 1 having a configuration of an offset h-frame allowing foldability of the frame substantially flat by two sets of hinged points and an off-set frame and wheel geometry.

8. A wheeled walker according to claim 2 wherein the first and second pivots of the handles are spaced to allow the first pivot to provide a height difference of the handles relative to the top of the back legs and the second pivot to provide a difference in orientation of the handles due to a difference in height to allow ready functional use of the handles.

9. A wheeled walker according to claim 8 wherein the first and second pivots are separately lockable such that in the collapsing mode only the first pivot, providing the height adjustment, needs to pivot to locate the handles substantially alongside the back legs for substantial planar arrangement of legs arms and seat for compact transport.

10. A wheeled walker according to claim 9 wherein the second pivot remains in a separate locked position to prevent need for readjustment when handles are returned to correct position around first pivots when again in use.

11. A wheeled walker according to claim 1 wherein the handles substantially overly the rear pivot connection of the seat to the back legs, allowing the user to walk between the lower parts of the back legs and receive suitable support from the walker and to sit on the seat.

12. A wheeled walker according to claim 11 wherein a hooped support extends forwardly from the first pivot to form a backrest when the user is resting on the seat.

13. A wheeled walker according to claim 12 wherein the hooped support pivots substantially alongside the top of the back legs when in a compact transportable non-use position.

14. A wheeled walker according to claim 13 wherein the respective attachment of the wheels to the lower ends of the front and rear legs is offset to allow alongside positioning in a compact transportable non-use position which is achieved when the front caster wheels are mounted centrally on the end of the front legs and the rear fixed wheels are mounted offset on the outer side of the back legs.

15. A wheeled walker having one or more front leg structures carrying front wheels on their lower ends, and one or more back leg structures carrying back wheels on their lower ends with the front and back wheels offset, a seat spacing and extending between opposing front and rear leg structures, and handles extending from an upper portion of the front or rear leg structures, wherein the wheeled walker includes a first pivoting connection between the front leg structures and one side of the seat and a second pivoting connection between the back leg structures and the opposing side of the seat to allow collapse of the wheeled walker to a substantially planar storage form.

16. A wheeled walker according to claim 15 wherein the structure of the seat includes a four-point perimetric located locking means which simultaneously locks and unlocks the four point locking at the pivot points at the spaced connections.

17. A wheeled walker according to claim 16 wherein the four point locking includes a centrally located arm extending around the seat and engaging between opposing pairs of pivot locks to simultaneously lock or unlock the four point locking pivot points.

18. A wheeled walker according to claim 17 having at an upper end of the legs a pair of pivotably mounted handles having rearwardly protruding arms ending in hand grips with the handles further including a second pivot along the handles, wherein the user can adjust the height of the handles while also adjusting the orientation wherein the pivoting relationship between the handles and the main frame allow for at least 2 degrees of height adjustment of the handles.
